(19) United States
(12) Patent Application Publication
(10) Pub. No.: US 2026/0245266 A1
(43) Pub. Date: Aug. 20, 2026

(54) CONTROL SYSTEM, MEASUREMENT APPLICATION SYSTEM, MEASUREMENT APPLICATION DEVICE, AND METHOD

(71) Applicant: Rohde & Schwarz GmbH & Co. KG, München (DE)

(72) Inventors: Thomas ROESNER, München (DE); Veronika STELLWAG, München (DE); Lorenz STORTZ, München (DE); Thomas BRAUNSTORFINGER, München (DE); Johannes STEFFENS, Rosenheim (DE); Volker OHLEN, Pliening (DE); Nikola SERDAR, München (DE); Dominik HETTICH, Germering (DE)

(21) Appl. No.: 19/362,218

(22) Filed: Oct. 17, 2025

(30) Foreign Application Priority Data
Feb. 20, 2025 (DE) DE102025106583.7

(51) Int. Cl. G06T 11/00; G06F 3/01

(52) U.S. Cl. CPC G06T 11/10; G06F 3/011; G06F 3/017

(57) ABSTRACT

The present disclosure provides a control system for measurement application devices, wherein the control system comprises an augmented-reality display unit, a device management unit configured to manage measurement application devices communicatively connected to the control system, and an output control unit configured to control the augmented-reality display unit such that it displays a status of a measurement task performed by the measurement application devices.

### TECHNICAL FIELD

The present disclosure relates to a control system for measurement application devices, a corresponding measurement application system, a corresponding measurement application device, and a corresponding method.

### BACKGROUND

The present disclosure is described below primarily in connection with controlling multiple networked measurement application devices. It is understood that the disclosure is not limited thereto and can also be used with individual measurement application devices.

The control or operation of measurement application devices presents a challenge for the respective user, particularly in larger measurement application systems with a plurality of measurement application devices.

On the one hand, the user must keep track of the plurality of measurement application devices to, for example, read measured values or configure the measurement application devices. On the other hand, the measurement application devices may be distributed within a room or arranged across multiple rooms.

### SUMMARY

An object of the disclosure is therefore to simplify the use of measurement application systems with a plurality of measurement application devices.

The object is solved by the subject matter of the independent claims.

Disclosed is:

A control system for measurement application devices, wherein the control system comprises an augmented-reality display unit, a device management unit configured to manage measurement application devices communicatively connected to the control system, and an output control unit configured to control the augmented-reality display unit such that it displays a status of a measurement task performed by the measurement application devices.

Further disclosed is:

An measurement application system comprising at least one control system according to the present disclosure, and at least one measurement application device, wherein the at least one measurement application device is communicatively coupled to the at least one control system.

Further disclosed is:

A measurement application device comprising at least one control system according to the present disclosure, and a communication interface configured to communicatively couple the measurement application device with at least one further measurement application device or a device under test.

Further disclosed is:

A computer-implemented method for operating a measurement application system, wherein the method comprises: receiving status information from measurement application devices of the measurement application system, determining a status of a measurement task performed by the measurement application devices, and outputting the status determined based on the status information in an augmented-reality display unit.

The present disclosure is based on the insight that it is difficult for a user to keep track of multiple measurement application devices and to operate or read them simultaneously.

The present disclosure addresses this insight and provides the control system, the measurement application system, and the corresponding method, which enable one or more users to easily use communicatively connected measurement application devices.

The control system for measurement application devices serves to identify the measurement application devices in a measurement application system and provide corresponding control options to a user.

For this purpose, the control system comprises a device management unit which handles the management of the measurement application devices. An output control unit serves to control an augmented-reality display unit such that at least the status of a measurement task performed by the measurement application devices is displayed to one or more users via the augmented-reality display unit.

The status of the measurement task can be displayed bundled in the augmented-reality display unit for all affected measurement application devices, regardless of where they are located or how they are connected to each other.

The term augmented-reality display unit is to be understood within the scope of this disclosure as any display that enables the overlay of images of the real world with computer-generated content. Such an augmented-reality display unit can, for example, display the computer-generated content on a semi-transparent display in the user's field of view, whereby the user continues to see their surroundings through the semi-transparent display. Alternatively, the augmented-reality display unit may comprise a non-transparent display in which a video recording of the user's surroundings is displayed, overlaid with the computer-generated content. The augmented-reality display unit may, for example, be implemented as a type of glasses worn by a user. The augmented-reality display unit may also be implemented as a walk-in room, on whose walls, floors, and/or ceilings corresponding content is displayed. Such systems may also be called “Cave Automatic Virtual Environment”, abbreviated: CAVE.

In embodiments, the output control unit and the device management unit may be implemented as a single unit. In particular, the output control unit and the device management unit may comprise a dedicated processing element or be provided as part of such, for example as a processing unit, processor, microcontroller, Field-Programmable Gate Array (FPGA), Complex Programmable Logic Device (CPLD), Application Specific Integrated Circuit (ASIC), or similar. A corresponding program or configuration may be provided to implement the required functionality. The output control unit and the device management unit may also be provided at least partially as a non-volatile computer program product containing computer-readable instructions executable by a processing element. In a further embodiment, the output control unit and the device management unit may be integrated as an additional function or method into the firmware or operating system of a processing element already present in the respective application, whereby the corresponding computer-readable instructions are provided. Such computer-readable instructions may be stored in a memory coupled to or integrated into the processing element. The processing element may load and execute the computer-readable instructions from the memory. This applies equally to all other elements, units, or functions disclosed herein as part of the control system, the measurement application system, and the measurement application device, such as the input unit.

Furthermore, it is understood that any necessary supporting or additional hardware, such as a power supply circuit and a clock generator circuit, may be provided. In general, any computer program or computer program product disclosed herein is to be understood as a non-volatile computer program product.

Managing the measurement application devices by the device management unit is understood to mean that the device management unit maintains at least a list of the measurement application devices to be managed, retrieves the relevant data for determining the status of the measurement task from the measurement application devices, and provides this data to the output control unit. Consequently, the device management unit serves as a kind of aggregator for the relevant data in the measurement application. Controlling the individual measurement application devices by the device management unit is also possible. This also applies to an electric or electronic device under test.

Via the augmented-reality display unit, this data, particularly the status of the measurement task, can be displayed to the user at any time, regardless of where the user is located or where the user directs their gaze. For example, the display of the status may follow the user's head movements so that the status is always visible at a specific location in their field of view.

The visualization of the status by the augmented-reality display unit may comprise, without being limited to these examples, progress bars, a list of measurement steps, numerical values, signal curves, measured value curves, and input elements for the measurement application devices.

The control system may further comprise an input unit, or the output control unit or the augmented-reality display unit, or both, may be configured to detect and evaluate user inputs. Accordingly, the control system may provide that the user can configure the display of the status. For example, user inputs may be detected through which the user can change for the status display in the augmented-reality display unit at least one of the following variables: position, size, color scheme, and intensity of the overlay.

Further user inputs may enable the user to adapt the contents of the status display, e.g., to add or remove contents. For this purpose, the device management unit may retrieve from the individual measurement application devices the contents retrievable from them and list them for the user to choose from.

In embodiments, the measurement application devices may tag the individual contents with an identifier indicating whether the respective contents should be displayed automatically or not. Those contents tagged for automatic display may be automatically displayed to the user in the status after identification of the respective measurement application device. Those contents not tagged for automatic display may, for example, only be displayed in the status after active selection of the corresponding contents by the user. It is understood that the user can also deactivate the contents tagged for automatic display so that they are no longer displayed in the status. In such embodiments, the status is automatically supplemented upon detection or addition of a measurement application device for a measurement task, so that the user directly receives the relevant information. In embodiments, the device management unit may comprise a database containing the information on the contents of the individual measurement application devices, so that this information does not have to be provided by the measurement application devices. This database may be updated regularly by the device management unit, for example, from a server of the manufacturer of the control system. A combination of the database with the retrieval of the information from the measurement application devices is also possible.

A measurement application device according to the present disclosure may comprise any device used in a measurement application to acquire an input signal or to generate an output signal, or which performs additional or supporting functions in a measurement application. A measurement application device may also be implemented as a program or software application executed as a measurement application on a computer or processor and capable of communicating with other measurement application devices to fulfill a measurement task. A measurement application, also referred to as a measurement or test setup, may comprise, for example, at least one or several different measurement application devices used for electrical, magnetic, or electromagnetic measurements, particularly on individual devices under test, also called DUT. A measurement application device according to the present disclosure may be configured to perform such electrical, magnetic, or electromagnetic measurements or signal generations, for example, in a measurement laboratory or in a production facility within the respective production line on a device under test. An exemplary measurement setup may serve to qualify the individual devices under test, i.e., to verify the proper electrical function of the respective devices under test.

For this purpose, measurement application devices may comprise at least one signal acquisition part for acquiring electrical, magnetic, or electromagnetic signals from the device under test and/or at least one signal generation part for generating electrical, magnetic, or electromagnetic signals that can be supplied to the device under test. Such a signal acquisition part may include, for example but not limited to, a front-end stage for acquiring, filtering, attenuating, or amplifying electrical signals. The signal generation part may include, for example but not limited to, corresponding signal generators, amplifiers, and filters. In embodiments, signal acquisition via the signal acquisition part is performed in a wired or contact-based manner. For this purpose, a corresponding measurement probe may be connected to the measurement application device via a corresponding cable. Likewise, in embodiments, signal generation and output via the signal generation part is performed in a wired or contact-based manner. For this, a corresponding signal output probe may be connected to the measurement application device via a corresponding cable, or the signal is output directly via the cable, e.g., to a device under test. In further embodiments, signal acquisition may be contactless, e.g., via corresponding antennas, also called OTA or over-the-air. In further embodiments, signal generation and output may be contactless, e.g., via corresponding antennas, also called OTA or over-the-air. A combination of contact-based signal acquisition, contactless signal acquisition, contact-based signal generation and output, and contactless signal generation and output is also possible.

Furthermore, measurement application devices may comprise a signal processing unit that processes the acquired signals during signal acquisition. The processing may include converting the acquired signals from analog to digital signals or vice versa and any other type of digital signal processing, for example converting time-domain signals to frequency-domain signals.

The measurement application devices may also comprise a user interface to display the acquired signals to the user and to enable the user to control the measurement application devices. Naturally, a housing may be provided that encloses the elements of the measurement application device. It is understood that additional elements such as a power supply circuit and communication interfaces may be provided.

A measurement application device may be a standalone device that can be operated in a measurement application without further elements to perform tests on a device under test. Naturally, communication capabilities may also be provided to connect the measurement application device with other measurement application devices.

A measurement application device may be, for example, a signal recording device such as an oscilloscope, particularly a digital oscilloscope, a spectrum analyzer, or a vector network analyzer. A measurement application device may also comprise a signal generation device, e.g., a signal generator, particularly a so-called “arbitrary signal generator”, also referred to as “arbitrary waveform generator”, or a vector signal generator. Further possible measurement application devices include devices such as calibration standards or probe tips.

Naturally, at least some of the possible functions, such as signal recording and signal generation, may be combined in a single measurement application device.

In embodiments, the measurement application device may comprise pure data acquisition devices capable of acquiring an input signal and transmitting the acquired input signal as a digital input signal to a corresponding data storage or application server. Such pure data acquisition devices do not necessarily comprise a user interface or display. Instead, such pure data acquisition devices may be remotely controlled, e.g., via a corresponding data connection such as a network interface or a USB interface. The same applies to pure signal generation devices that can generate an output signal without having a user interface or configuration input devices. Instead, such signal generation devices may be operated remotely via a data connection.

Further embodiments and developments emerge from the dependent claims as well as from the description with reference to the figures. In particular, all embodiments mentioned herein may be combined with each other in any order or number, unless individual features are mutually exclusive. In particular, dependent claims of one claim category may also be developed according to another claim category.

In an embodiment combinable with all embodiments mentioned herein, the device management unit or the output control unit may further be configured to adjust a background color in the augmented-reality display unit based on the status.

As already explained, the augmented-reality display unit can overlay the user's surroundings with corresponding content. To indicate a specific status more clearly to a user, the device management unit or the output control unit may control the augmented-reality display unit such that the entire background or at least a predefined area of the background is colored in a specific color. The statement “coloring the background” is understood to mean that the user's surroundings visible in the augmented-reality display unit are overlaid with a color, so that they appear colored in the corresponding color. The intensity of the overlay may be predefined or adjustable by the user. The intensity of the overlay may also be referred to as transparency, which can be adjusted by a so-called alpha value or alpha channel in a range from 0% to 100%. The user can adjust this value, for example, via a slider or an input field that may be displayed in the augmented-reality display unit. The term background color may also be referred to as background tint or background coloring.

By adjusting the background color, the user can be immediately informed about the status of a measurement application system without their field of view being restricted or space in their field of view being occupied by overlays.

If the entire background or the entire surroundings in the augmented-reality display unit are colored in the corresponding color, the user can be alerted to a specific status very quickly. If only a partial area of the surroundings displayed in the augmented-reality display unit is colored, the user can be individually alerted to the status of individual measurement application devices in their surroundings.

For example, the background may be colored in a predefined signal color, such as red, when a measurement task is paused or stopped and user intervention is necessary. In further examples, the background may be colored in another color, e.g., green, when a measurement task is currently being processed or no user intervention is necessary. For this purpose, the device management unit or the output control unit may be configured to map the state or status of the measurement task to the respective background color and, if set, to the respective area.

The background coloring may further be time-limited. For example, upon stopping the measurement task, the background may briefly be colored in a predefined signal color, such as red. The duration of the coloring may be predefined, e.g., 1, 2, or 3 seconds, or may be adjustable by a user.

In further embodiments, corresponding colors may be assigned to individual steps or groups of steps of a measurement task. When a corresponding step is executed, the background may be colored in the corresponding color. This allows a user to very easily recognize the progress in performing a measurement task.

In further embodiments, the device management unit or the output control unit may be configured to color the background in a color determined based on measured values provided by one of the measurement application devices. For this purpose, value ranges may be predefined for individual measured values, each assigned a corresponding color. If one of these measured values lies within the corresponding value range, the background in the augmented-reality display unit may be colored with the corresponding color. This enables a user to very quickly recognize whether a device under test is behaving as expected.

Furthermore, the device management unit or the output control unit may be configured or a corresponding computing unit may be provided to calculate a calculated value from multiple measured values acquired by the measurement application devices. In such embodiments, the background color may be set based on the calculated value, for which, as already explained above, corresponding value ranges and colors can be predefined. Corresponding calculation formulas may be predefined for different measurement tasks or the user may enter corresponding formulas.

In an embodiment combinable with all embodiments mentioned herein, the device management unit or the output control unit may further be configured to adjust a background color in the augmented-reality display unit based on a currently controlled measurement application device.

The background color may not only be set based on the status of the measurement application system. In particular, the background color may also be set based on the currently selected or controlled measurement application device.

In an augmented-reality environment, a user can move freely or freely change their viewing direction. If the background color is set based on the currently controlled measurement application device, the user is informed at all times, regardless of their viewing direction, about which device their inputs are being applied to. This is particularly advantageous when the user has anchored the status display at a fixed position in their field of view. In such situations, the user sees the status and possibly corresponding input elements regardless of their viewing direction. The user can therefore make inputs via such input elements even when they do not see the corresponding measurement application device in their field of view. By coloring the background, the user remains continuously informed about which measurement application device their input refers to. The output control unit may provide that the user can set the colors for the respective measurement application devices. Furthermore, the user may specify areas of the surroundings or their field of view to be used for displaying the currently controlled measurement application device. In particular, the user may specify different areas, one of which may be used for displaying the status and one for displaying the controlled measurement application device.

For example, the lower half may be used for displaying the status and the upper half for displaying the controlled measurement application device, or vice versa. The left half may also be used for displaying the status and the right half for displaying the controlled measurement application device, or vice versa.

In an embodiment combinable with all embodiments mentioned herein, the device management unit or the output control unit may further be configured to select the currently controlled measurement application device based on a physical distance of a user from the measurement application devices or a viewing direction of the user.

Typically, a user must themselves select or decide which of the measurement application devices they wish to control with their inputs. However, in an augmented-reality environment, this can also be facilitated or taken over for a user.

For this purpose, the physical distance of the user from the respective measurement application device may be determined, and the controlled measurement application device may be automatically selected to which the user is closest. Additionally or alternatively, that measurement application device may be selected which lies in the viewing direction of the user. This enables a user, for example, to approach a measurement application device, configure it via the augmented-reality display unit, then turn their gaze to a more distant measurement application device, and immediately thereafter configure it via the augmented-reality display unit without approaching it.

In an augmented-reality environment in which the user's surroundings are overlaid with content, the expression “physical distance” can be understood as the actual distance of the user from the respective measurement application device.

In an augmented-reality environment in which a video of the surroundings is displayed and overlaid with further content, a user may move in a virtual space regardless of their actual position in reality. In such an embodiment, the expression “physical distance” may also be understood as the distance of the user's position in the virtual space from a measurement application device displayed in the virtual space.

In an embodiment combinable with all embodiments mentioned herein, the control system may further comprise an input unit configured to detect input gestures of the user and to control the augmented-reality display unit, or at least one of the measurement application devices, or the augmented-reality display unit and at least one of the measurement application devices based on the detected input gestures.

As already explained above, the augmented-reality display unit can not only be used for displaying information. Rather, an input unit may be provided in the control system, which is configured to detect inputs, particularly input gestures, of the user.

Based on these input gestures, the augmented-reality display unit, or at least one of the measurement application devices, or both may be controlled.

In connection with the display unit, “controlling” is to be understood as adjusting the display on the augmented-reality display unit. For example, as mentioned above, it can be controlled via corresponding inputs which background areas in the augmented-reality environment are to be colored in which colors based on which data.

If the control relates to the measurement application devices, “controlling” can be understood as any input to or configuration of the measurement application device that a user could also perform directly on the physical measurement application device or transmit to the physical measurement application device via a communication interface.

In embodiments, the input unit may be a unit that detects inputs, particularly gestures and voice commands, of the user via corresponding sensors, e.g., a camera, ultrasonic sensors, laser sensors, microphones, and the like. The input unit may additionally or alternatively be implemented as a virtual input unit that can be displayed in the user's field of view. In particular, the virtual input unit may be displayed in the field of view when a corresponding gesture or a corresponding voice command has previously been received from the user.

The virtual input unit may be displayed as a type of menu comprising different menu items enabling the user, for example, to configure the augmented-reality display unit. The virtual input unit may also be displayed as a virtual instrument replicating a physical measurement application device or parts of its input elements.

In an embodiment combinable with all embodiments mentioned herein, the input unit may further be configured to adapt the possible input gestures based on the status or a currently controlled measurement application device.

As already explained above, the input unit may receive input gestures from a user and convert them into configuration or control commands accordingly.

In complex measurement application systems with a plurality of measurement application devices, a plurality of input gestures may be provided that enable controlling individual aspects of the measurement application system. This requires the user to memorize this multitude of gestures and may lead to the user confusing input gestures and thus performing them incorrectly or wrongly.

If the possible input gestures are adapted based on the current status of the measurement application system or a currently controlled measurement application device, the number of possible input gestures can be restricted situationally or contextually. Thereby, the number of possible gestures for the user is reduced.

Adapting possible input gestures is not only to be understood as selecting gestures. Adapting possible input gestures may also consist in that the same gesture is applied to a different measurement application device depending on the situation.

In an embodiment combinable with all embodiments mentioned herein, the input unit may further be configured to adapt the effect of the input gestures based on the status, or a currently controlled measurement application device, or the distance of a user to a currently controlled measurement application device.

As already explained above, the available input gestures can be adapted situationally. This adaptation may concern not only the availability but also the effect of the respective input gestures.

For example, zones or distance ranges may be predefined, and corresponding effects or functions may be assigned to individual input gestures for the respective zones. These assignments may be predefined individually for each of the measurement application devices and stored, e.g., in the output control unit or the input unit. In embodiments, individual users may configure and store the input gestures individually for themselves.

With the effect of the input gestures, the background color of the display in the augmented-reality display unit, as already explained above, may simultaneously be adjusted depending on the distance of a user from the respective measurement application device. Thus, the user easily recognizes what effect an input gesture will have in the current situation.

For example, the adaptation of the effect of a zoom input gesture for displaying one of the measurement application devices may be such that, depending on the distance, the zoom effect of the input gesture is stronger or weaker. If a user is further away from a measurement application device, the zoom effect may be stronger than in situations where the user is close to the measurement application device, since the user, for example, sees the displayed waveforms larger in front of them near the measurement application device and may want to control more finely. The same may apply, for example, to a scroll input gesture and other input gestures.

In an embodiment combinable with all embodiments mentioned herein, the input unit may further be configured to receive an input gesture for selecting several of the measurement application devices and to apply subsequent input gestures to the selected measurement application devices.

The input gesture for selecting several of the measurement application devices may be a single input gesture that comprises, for example, circling the desired measurement application devices in the augmented-reality display unit. Alternatively, the input gesture may comprise a series of selection gestures, e.g., pointing at or pointing at and bringing together thumb and index finger, with which the corresponding measurement application devices are selected one after the other. The first input gesture that is not the selection gesture may then be used to control all selected measurement application devices.

Furthermore, an input gesture may be provided that dissolves the grouping of multiple measurement application devices for joint control.

The output control unit may further be configured to save the created groups of measurement application devices upon a corresponding input gesture from the user or automatically.

In an embodiment combinable with all embodiments mentioned herein, the device management unit or the output control unit may be configured to display different information of the status on different surfaces of a three-dimensional body in the augmented-reality display unit.

As already explained above, the status may comprise different information, such as configuration data, measurement data, signal progressions, and the like, relating to the measurement application system as well as the individual measurement application devices and the electrical and electronic devices under test. It is understood that the term electrical device within the scope of this disclosure is equivalent to the term electronic device and no distinction is made between electrical and electronic devices within the scope of this disclosure.

The actual form of the three-dimensional body may take different shapes. In embodiments, different shapes, such as cubes, cuboids, prisms, and pyramids, may be predefined for selection. Additionally or alternatively, a user may create their own three-dimensional bodies via corresponding input gestures.

The output control unit may further provide that the user assigns corresponding content to the individual surfaces of the three-dimensional body via corresponding input gestures.

For example, one surface of a cube may be assigned the display of measured values acquired by a measurement application device, while on another surface of the cube, configuration input elements for the corresponding measurement application device may be displayed.

Via corresponding input gestures, the user can adjust the position and orientation of the three-dimensional body. The user may specify the position relative to their field of view so that the three-dimensional body moves with their field of view. Alternatively, the user may fix the position in space so that the three-dimensional body is located at a fixed position in the user's surroundings and is only displayed to them when they look in the corresponding direction.

The output control unit may also enable the user to create multiple three-dimensional bodies with individually displayable information and positions.

In an embodiment combinable with all embodiments mentioned herein, the measurement application system may further comprise at least one electrical or electronic device under test communicatively coupled to the at least one control system.

### BRIEF DESCRIPTION OF THE DRAWINGS

The present disclosure is explained in more detail below with reference to the exemplary embodiments indicated in the schematic figures of the drawings.

FIG. 1 shows a block diagram of an embodiment of a control system according to the present disclosure;

FIG. 2 shows a block diagram of a further embodiment of a control system according to the present disclosure;

FIG. 3 shows a block diagram of an embodiment of a measurement application device according to the present disclosure;

FIG. 4 shows a block diagram of an embodiment of a measurement application system according to the present disclosure;

FIG. 5 shows a a flowchart of an embodiment of a method according to the present disclosure;

FIG. 6 shows a block diagram of an embodiment of an oscilloscope that can serve as a measurement application device according to the present disclosure; and

FIG. 7 shows a block diagram of an embodiment of a further oscilloscope that can serve as a measurement application device according to the present disclosure.

In all figures, functionally equivalent elements and devices—unless otherwise specified—are provided with similar reference signs that match at least in the two least significant digits (units and tens).

### DETAILED DESCRIPTION OF THE DRAWINGS

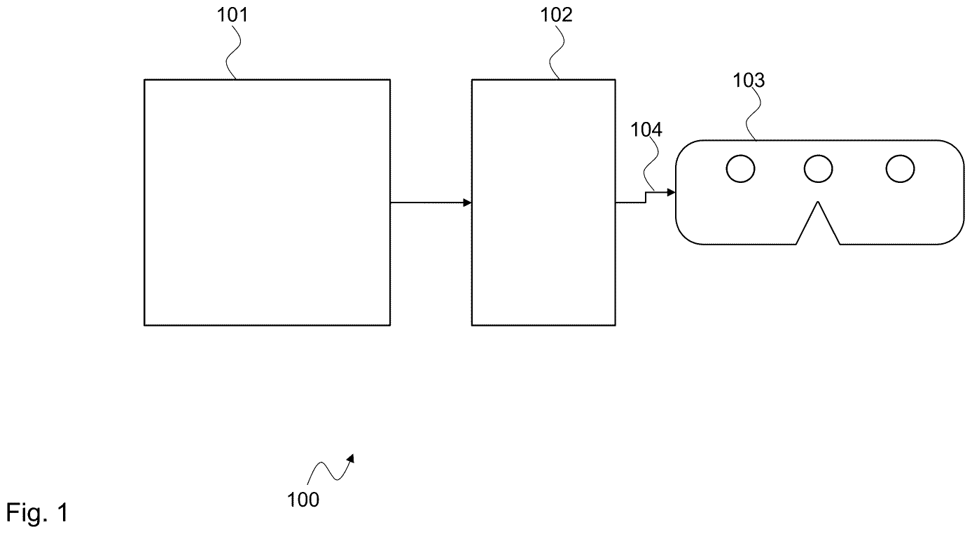

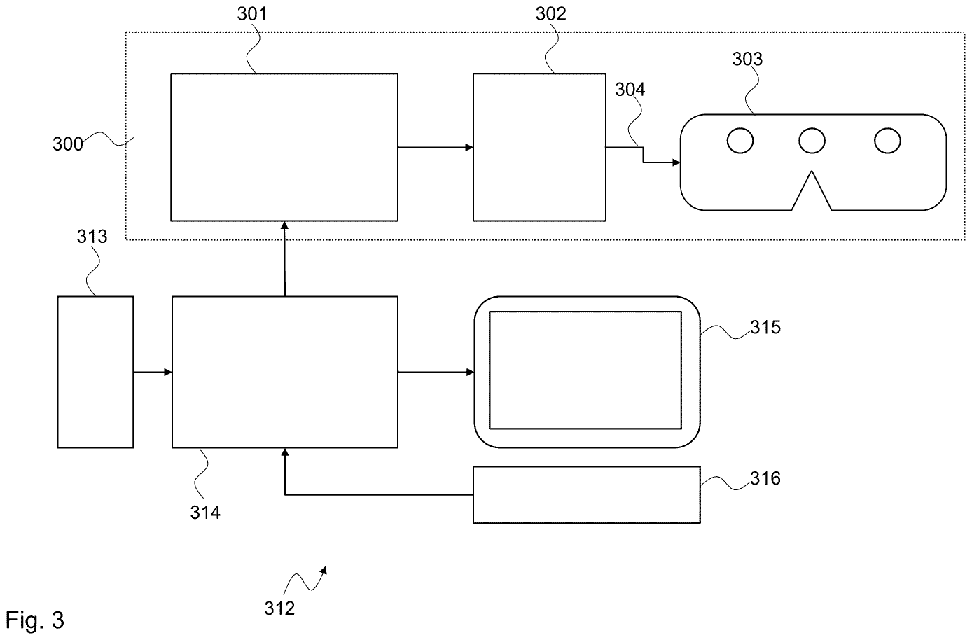

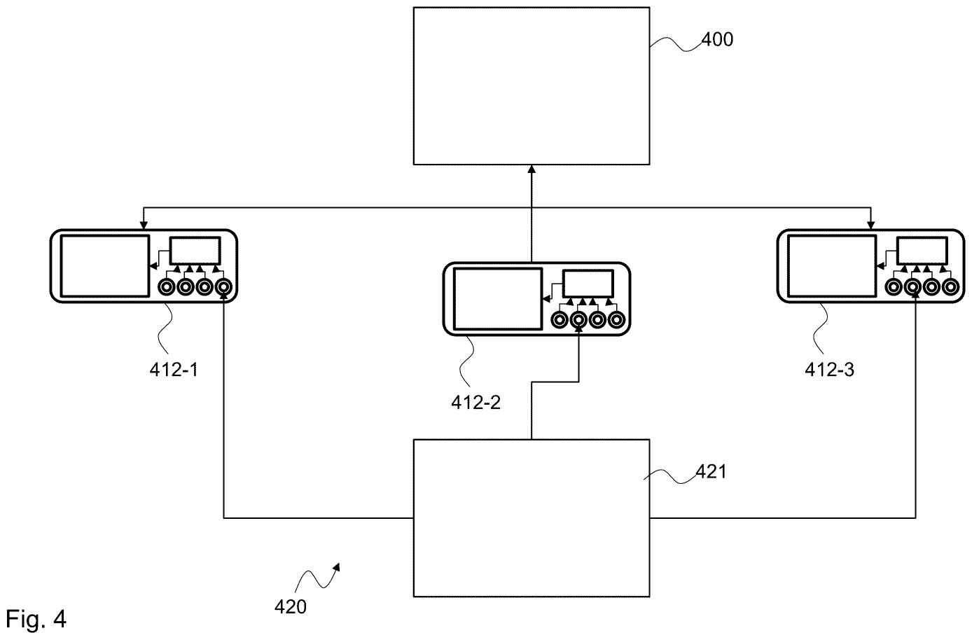

FIG. 1 shows a control system 100. The control system 100 serves to operate measurement application devices, see, e.g., FIG. 3, within a measurement application system, see, e.g., FIG. 4. The control system 100 comprises a device management unit 101 coupled to an output control unit 102. The output control unit 102 is coupled to an augmented-reality display unit 103. The explanations for other embodiments of the control system apply—mutatis mutandis—to the control system 100.

The device management unit 101 can manage various measurement application devices communicatively connected to the control system 100. The communicative connection can be established via any type of communication interface. Such communication interfaces may include any type of wired and wireless communication interfaces, such as a network interface, especially an Ethernet, Wireless LAN, or WIFI interface, a USB interface, a Bluetooth interface, an NFC interface, a visible or non-visible light-based interface, especially an infrared interface.

The output control unit 102 serves to control the augmented-reality display unit 103 such that it displays a status 104 of a measurement task performed by the measurement application devices. A measurement task may include any type of signal acquisition and signal generation of electrical signals. Different measurement application devices may be used to generate and acquire the signals. These may be coupled to the device management unit 101, which can control the sequence of the measurement task. Alternatively, a separate control unit may be provided for controlling the sequence of the measurement task.

The output control unit 102 may display different information of the status 104 on different surfaces of a three-dimensional body in the augmented-reality display unit 103.

The augmented-reality display unit 103 is depicted as so-called AR glasses. It is understood that any other type of augmented-reality display unit 103 may be used with the control system 100.

The output control unit 102 may be configured to adjust a background color in the augmented-reality display unit 103 based on the status 104. The output control unit 102 may further adjust the background color in the augmented-reality display unit 103 based on a currently controlled measurement application device. The status may, for example, be determined by the device management unit 101 or by the output control unit 102 itself. Adjusting the background color may be transmitted by the device management unit 101 as a control command to the output control unit 102, or the output control unit 102 may determine the background color itself based on the status 104.

The device management unit 101 or the output control unit 102 may further select the currently controlled measurement application device based on a physical distance of a user from the measurement application devices or a viewing direction of the user.

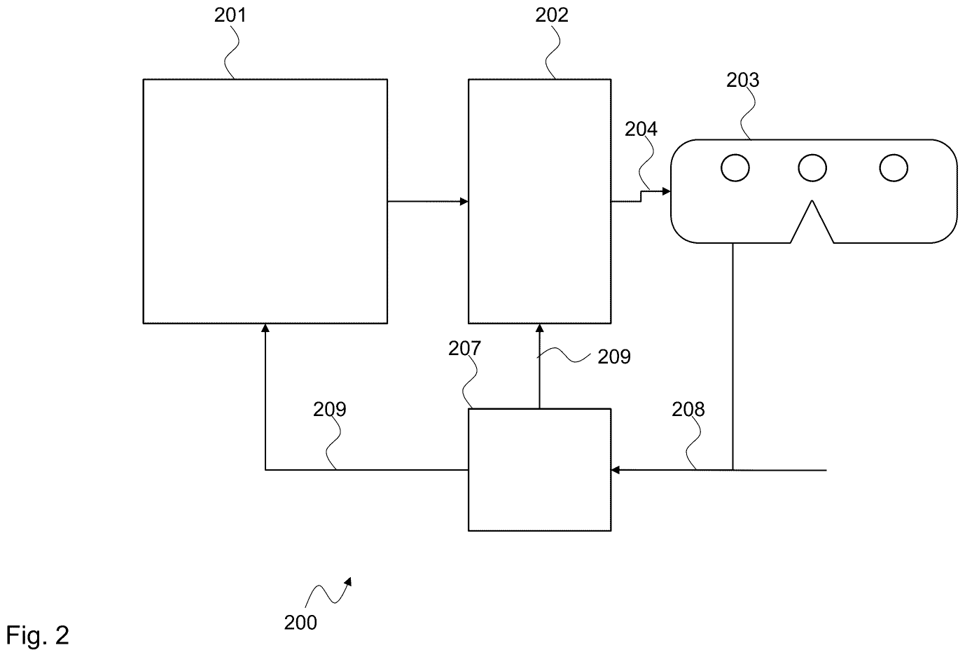

FIG. 2 shows a block diagram of a control system 200. The control system 200 is based on the control system 100. Therefore, the control system 200 comprises a device management unit 201 coupled to an output control unit 202. The output control unit 202 is coupled to an augmented-reality display unit 203. The explanations for other embodiments of the control system apply—mutatis mutandis—to the control system 200.

The control system 200 further comprises an input unit 207 that can detect input gestures 208 of a user. The input unit 207 can control the augmented-reality display unit 203, or at least one of the measurement application devices, or both, based on the detected input gestures 208. For this purpose, the input unit 207 may transmit the detected input gestures 208 or corresponding control commands to the output control unit 202 or to the measurement application devices. To the measurement application devices, the input unit 207 may transmit the input gestures 208 directly or via the device management unit 201. In embodiments, the input unit 207 may be integrated into the device management unit 201.

The input unit 207 may further adapt the possible input gestures 208, i.e., the input gestures 208 available to a user, based on the status 204 or a currently controlled measurement application device. The input unit 207 may further adapt the effect of the input gestures 208 based on the status 204, or a currently controlled measurement application device, or the distance of a user to a currently controlled measurement application device, as explained above.

The input unit 207 may further receive an input gesture 208 for selecting several of the measurement application devices and apply subsequent input gestures to the selected measurement application devices.

FIG. 3 shows a block diagram of an embodiment of a measurement application device 312. The measurement application device 312 comprises an exemplary measurement input 313, wherein multiple measurement inputs are possible. Furthermore, the measurement application device 312 comprises a processing unit 314 coupled to the measurement input 313 and to a display 315. The measurement application device 312 further comprises an input interface 316 via which a user can operate the measurement application device 312.

Furthermore, a control system 300 is provided in the measurement application device 312. The control system 300 corresponds to the control system 100. However, the measurement application device 312 can be used with all other embodiments of the measurement application device disclosed herein.

The device management unit 301 of the control system 300 is coupled to the processing unit 314. In embodiments, the device management unit 301 may also be integrated into the processing unit 314.

FIG. 4 shows a block diagram of a measurement application system 420. The measurement application system 420 comprises a control system 400, which is exemplarily coupled to three measurement application devices 412-1, 412-2, and 412-3. The control system 400 may be any embodiment of the control system disclosed herein. The measurement application system 420 may comprise more or fewer measurement application devices. The measurement application devices 412-1, 412-2, and 412-3 are coupled to a device under test 421, to which they can transmit test signals or from which they can acquire test signals. In embodiments, the device under test 421 may also be directly coupled to the control system 400.

For easier understanding, the reference signs from FIGS. 1-4 are retained as references in the following description.

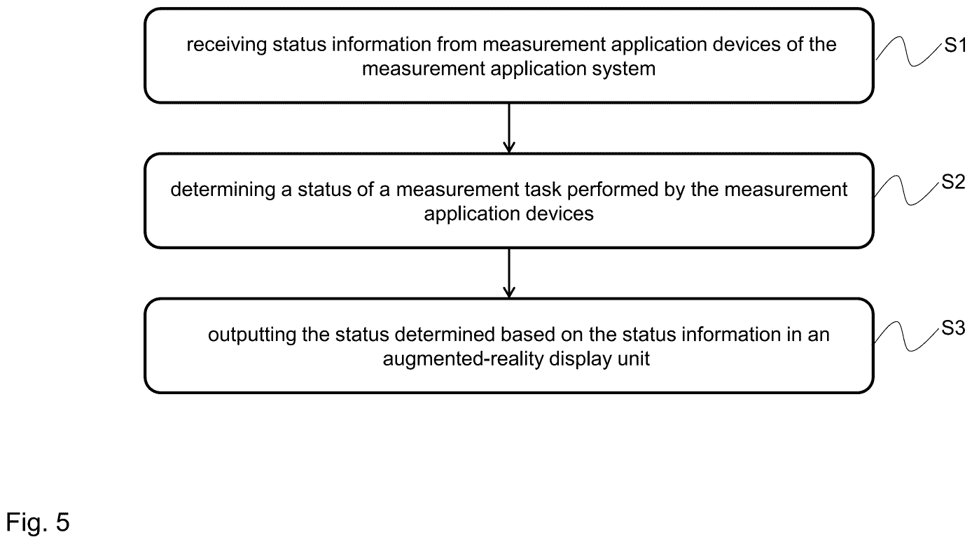

FIG. 5 shows a flowchart of an embodiment of a computer-implemented method for operating a measurement application system.

The method comprises: receiving S1 status information from measurement application devices 312, 412-1, 412-2, 412-3 of the measurement application system; determining S2 a status 104, 204, 304 of a measurement task performed by the measurement application devices 312, 412-1, 412-2, 412-3; and outputting S3 the status 104, 204, 304 determined based on the status information in an augmented-reality display unit 103, 203, 303.

The method may further comprise adjusting a background color in the augmented-reality display unit 103, 203, 303 based on the status 104, 204, 304. The background color in the augmented-reality display unit 103, 203, 303 may further be adjusted based on a currently controlled measurement application device 312, 412-1, 412-2, 412-3. The currently controlled measurement application device 312, 412-1, 412-2, 412-3 may, for example, be selected based on a physical distance of a user from the measurement application devices 312, 412-1, 412-2, 412-3 or a viewing direction of the user. Alternatively, the currently controlled measurement application device 312, 412-1, 412-2, 412-3 may, for example, be selected directly by a user by pointing or clicking.

The method may further comprise detecting input gestures 208 of the user and controlling the augmented-reality display unit 103, 203, 303, or at least one of the measurement application devices 312, 412-1, 412-2, 412-3, or both based on the detected input gestures 208.

The possible input gestures 208 may be adapted based on the status 104, 204, 304 or a currently controlled measurement application device 312, 412-1, 412-2, 412-3. Furthermore, the effect of the input gestures 208 may be adapted based on the status 104, 204, 304, or a currently controlled measurement application device 312, 412-1, 412-2, 412-3, or the distance of a user to a currently controlled measurement application device 312, 412-1, 412-2, 412-3.

The method may comprise receiving an input gesture 208 for selecting several of the measurement application devices 312, 412-1, 412-2, 412-3, wherein subsequent input gestures 208 are applied to the selected measurement application devices 312, 412-1, 412-2, 412-3.

The method may further comprise displaying different information of the status 104, 204, 304 on different surfaces of a three-dimensional body in the augmented-reality display unit 103, 203, 303.

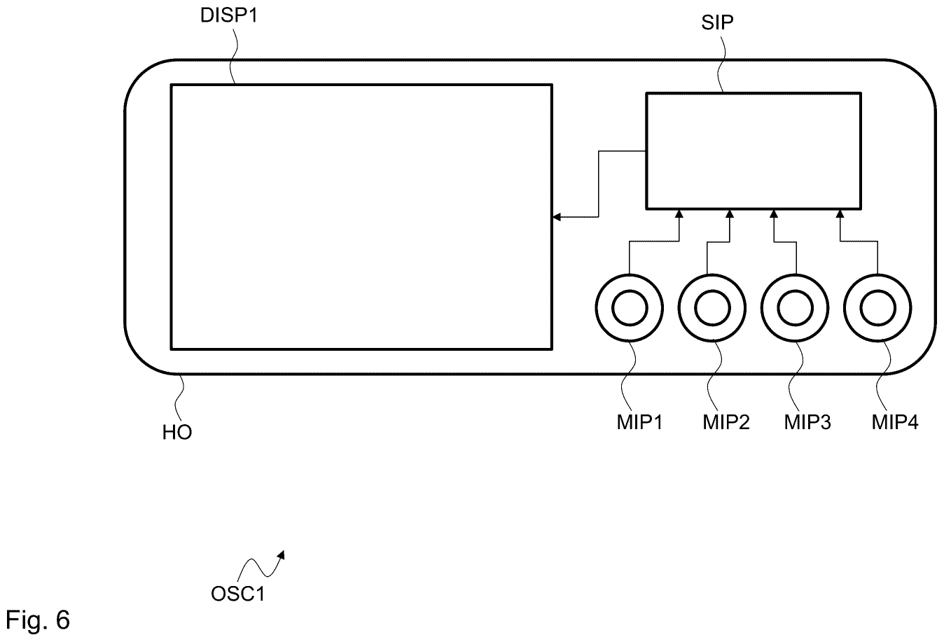

FIG. 6 shows a block diagram of an oscilloscope OSC1, which can implement an embodiment of a measurement application device according to the present disclosure.

The oscilloscope OSC1 comprises a housing HO that accommodates four measurement inputs MIP1, MIP2, MIP3, MIP4 connected to a signal processor SIP to process measured signals. The signal processor SIP is connected to a display DISP1 to display the measured signals to a user.

Although not explicitly shown, it is understood that the oscilloscope OSC1 may also comprise signal outputs. Such signal outputs may, for example, serve to output calibration signals. Such calibration signals allow calibration of the measurement setup before performing measurements. The process of calibrating and correcting measurement signals based on calibration may also be referred to as “de-embedding” and may involve applying corresponding algorithms to the generated or measured signals.

In the oscilloscope OSC1, the signal processor SIP or an additional processing element may execute or implement the function of the device management unit, the output control unit, or the input unit according to the present disclosure. Naturally, a communication interface for communication with other measurement application devices may be provided in the oscilloscope OSC1.

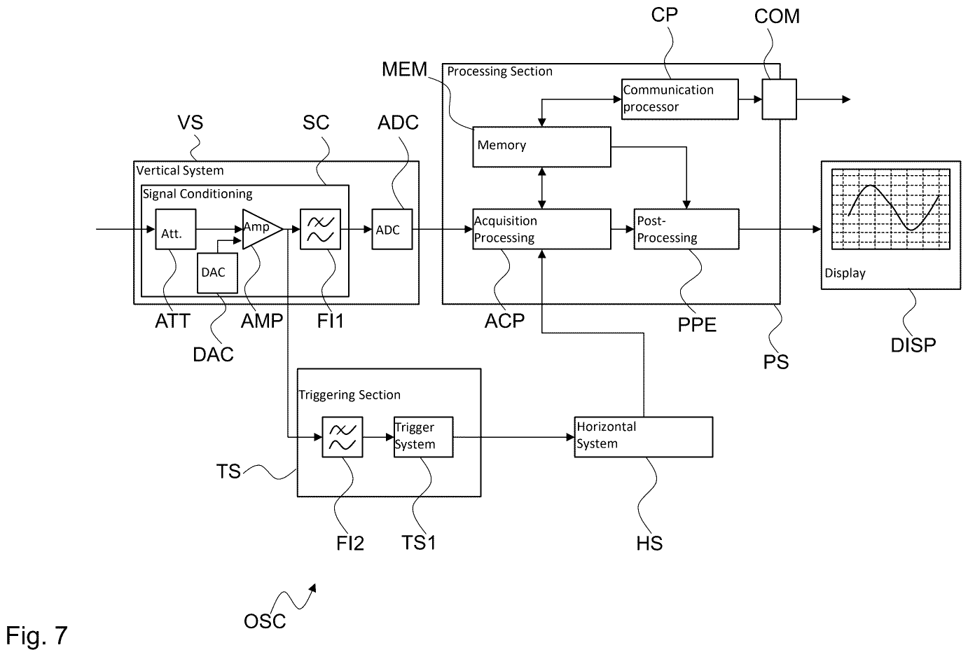

FIG. 7 shows a block diagram of an oscilloscope OSC that can implement a measurement application device according to the present disclosure. The oscilloscope OSC is implemented as a digital oscilloscope. However, it is noted that the present disclosure can also be implemented with any other type of oscilloscope.

The oscilloscope OSC exemplarily comprises five general sections: the vertical system VS, the triggering section TS, the horizontal system HS, the processing section PS, and the display DISP. It is understood that the division into five general sections represents a logical division and in no way restricts the placement and implementation of the elements of the oscilloscope OSC.

The vertical system VS primarily serves to offset, attenuate, and amplify a signal to be acquired. The signal may, for example, be modified to fit within the available display area of the display DISP or to have a vertical size configured by a user.

For this purpose, the vertical system VS comprises a signal conditioning section SC with an attenuator ATT and a digital-to-analog converter DAC connected to an amplifier AMP. The amplifier AMP is connected to a filter FI1, which is provided as a low-pass filter in the example shown. The vertical system VS also comprises an analog-to-digital converter ADC that receives the output of the filter FI1 and converts the received analog signal into a digital signal.

The attenuator ATT and the amplifier AMP serve to adjust the amplitude of the signal to be acquired to the operating range of the analog-to-digital converter ADC. The digital-to-analog converter DAC serves to modify the DC component of the input signal to be acquired so that it fits within the operating range of the analog-to-digital converter ADC. The filter FI1 serves to filter out unwanted high-frequency components of the signal to be acquired.

The triggering section TS operates with the signal provided by the amplifier AMP. The triggering section TS comprises a filter FI2, which is implemented as a low-pass filter in this embodiment. The filter FI2 is connected to a trigger system TS1.

The triggering section TS serves to detect predefined signal events and enables the horizontal system HS to, for example, display a stable view of a repeated waveform or simply display waveform sections containing the respective signal event. It is understood that the predefined signal event can be configured by a user via a user input of the oscilloscope OSC.

Possible predefined signal events may include, but are not limited to, when the signal exceeds a predefined trigger threshold in a predefined direction, i.e., with a rising or falling edge. Such a trigger condition is also referred to as an edge trigger. Another trigger condition is referred to as “glitch triggering” and triggers when a pulse occurs in the signal to be acquired whose width is greater or less than a predefined time.

To enable precise matching of the trigger signal with the waveform displayed on the display DISP, a common time base may be provided for the analog-to-digital converter ADC and the trigger system TS1.

It is understood that, although not explicitly shown, the trigger system TS1 may comprise at least one of the following components: configurable voltage comparators for setting trigger thresholds, fixed voltage sources for setting the required edge, corresponding logic gates such as an XOR gate, and flip-flops for generating the trigger signal.

The triggering section TS is exemplarily provided as an analog trigger section. It is understood that the oscilloscope OSC may also be equipped with a digital trigger section. Such a digital trigger section operates not with the analog signal provided by the amplifier AMP, but with the digital signal provided by the analog-to-digital converter ADC.

A digital trigger section may comprise a processing element, such as a processor, DSP, CPLD, ASIC, or FPGA, to implement digital algorithms for detecting a valid trigger signal.

The horizontal system HS is connected to the output of the trigger system TS1 and primarily serves to position and scale the signal to be acquired horizontally on the display DISP.

The oscilloscope OSC further comprises a processing section PS that implements digital signal processing and data storage for the oscilloscope. The processing section PS comprises an acquisition processing element ACP connected to the output of the analog-to-digital converter ADC and the output of the horizontal system HS, as well as to a memory MEM and a post-processing element PPE.

The acquisition processing element ACP manages the acquisition of digital data from the analog-to-digital converter ADC and the storage of the data in the memory MEM. The acquisition processing element ACP may, for example, comprise a processing element that has a digital interface to the analog-to-digital converter ADC and a digital interface to the memory MEM. The processing element may, for example, comprise a microcontroller, DSP, CPLD, ASIC, or FPGA with corresponding interfaces. In a microcontroller or DSP, the functionality of the acquisition processing element ACP may be implemented as computer-readable instructions executed by a CPU. In a CPLD or FPGA, the functionality of the acquisition processing element ACP may be configured in the CPLD or FPGA instead of having software executed by a processor.

The processing section PS further comprises a communication processor CP and a communication interface COM.

The communication processor CP may be a device that manages data transfer to and from the oscilloscope OSC. The communication interface COM may be designed for any suitable communication standard, such as Ethernet, WIFI, Bluetooth, NFC, an infrared communication standard, and a visible-light-based communication standard.

The communication processor CP is connected to the memory MEM and may use the memory MEM to store and retrieve data.

Naturally, the communication processor CP may also be connected to any other element of the oscilloscope OSC to retrieve device data or provide device data, e.g., received from a management server.

The post-processing element PPE may be controlled by the acquisition processing element ACP and may access the memory MEM to retrieve data to be displayed on the display DISP. The post-processing element PPE may process the data stored in the memory MEM so that the display DISP can display the data, for example, as a waveform to a user. The post-processing element PPE may also implement analysis functions such as cursors, waveform measurements, histograms, or mathematical functions.

The display DISP controls all aspects of signal representation for a user and may, although not explicitly shown, include any component required to receive display data and control a display device to display the data as desired.

It is understood that the oscilloscope OSC, even if not depicted, may comprise a user interface via which a user can interact with the oscilloscope OSC. Such a user interface may include dedicated input elements such as buttons and switches. At least partially, the user interface may also be provided as a touch-sensitive display device.

In the oscilloscope OSC, one of the processing elements, also referred to as computing elements, in the processing section PS or an additional processing element may perform the function of the device management unit, the output control unit, or the input unit according to the present disclosure.

It is understood that all elements of the oscilloscope OSC that perform digital data processing may be provided as dedicated elements. Alternatively, at least some of the functions described above may be implemented in a single hardware element, such as a microcontroller, DSP, CPLD, or FPGA. In general, the logical functions described above may be implemented in any suitable hardware element of the oscilloscope OSC and need not necessarily be divided into the various sections described above.

The processes, methods, or algorithms disclosed herein may be transferred to or implemented by a computing unit, controller, or computer. These may include any existing programmable electronic control unit or dedicated electronic control unit. Likewise, the processes, methods, or algorithms may be stored as data and instructions executable by a controller or computer in many forms, including but not limited to information permanently stored on non-writable storage media such as ROM devices, and information alterably stored on writable storage media such as floppy disks, magnetic tapes, CDs, RAM, and other magnetic and optical media. The processes, methods, or algorithms may also be implemented in a software-executable object. Alternatively, the processes, methods, or algorithms may be embedded wholly or partially in suitable hardware components such as application-specific integrated circuits (ASICs), field-programmable gate arrays (FPGAs), state machines, controllers, or other hardware components or devices, or a combination of hardware, software, and firmware components.

Although exemplary embodiments have been described above, it is understood that these embodiments do not encompass all possible forms of the present disclosure covered by the claims. The terms used in the specification are for description and not limitation, and it is understood that various changes may be made without departing from the spirit and scope of the disclosure. As previously described, features of various embodiments may be combined to form further embodiments of the invention that may not be explicitly described or illustrated. While various embodiments may be described as advantageous or preferred over other embodiments or prior art implementations with respect to one or more desired characteristics, those skilled in the art recognize that one or more features or characteristics may be adjusted to favor desired overall system attributes, depending on the specific application and implementation. These attributes may include, but are not limited to, cost, strength, durability, lifecycle cost, marketability, appearance, packaging, size, serviceability, weight, manufacturability, ease of assembly, etc. Thus, to the extent that embodiments are described as less desirable than other embodiments or prior art implementations with respect to certain characteristics, such embodiments are nevertheless within the scope of the disclosure and may be desirable for specific applications.

Regarding the processes, systems, methods, heuristics, etc., described herein, it is understood that although the steps of such processes, etc., have been described in a particular order, such processes may also be performed in an order different from that described herein. Likewise, it is understood that certain steps may be performed concurrently, that other steps may be added, or that certain steps described herein may be omitted. In other words, the descriptions of the processes herein are provided to illustrate certain embodiments and should in no way be construed as limiting the claims.

In summary, it is understood that the disclosed subject matter may be modified and varied without departing from the scope of the present disclosure.

All terms used in the claims are intended to be given their broadest reasonable constructions and their ordinary meanings as understood by those knowledgeable in the technologies described herein, unless explicitly stated otherwise. In particular, the use of singular articles such as “a,” “the,” “said,” etc., should be read to include one or more of the specified elements, unless a claim expressly states otherwise.

### LIST OF REFERENCE SIGNS

100, 200, 300, 400 Control system
101, 201, 301 Device management unit
102, 202, 302 Output control unit
103, 203, 303 Augmented-reality display unit
104, 204, 304 Status
207 Input unit
208 Input gesture
209 Control command
312, 412-1, 412-2, 412-3 Measurement application device
313 Measurement input
314 Processing unit
315 Display
316 Input interface
420 Measurement application system
421 Device under test
S1-S3 Method steps
OSC1 Oscilloscope
HO Housing
MIP1, MIP2, MIP3, MIP4 Measurement input
SIP Signal processor
DISP1 Display
OSC Oscilloscope
VS Vertical system
SC Signal conditioning section
ATT Attenuator
DAC Digital-to-analog converter
AMP Amplifier
FI1 Filter
ADC Analog-to-digital converter
TS Triggering section
AMP2 Amplifier
FI2 Filter
TS1 Trigger system
HS Horizontal system
PS Processing section
ACP Acquisition processing element
MEM Memory
PPE Post-processing element
DISP Display

1. A control system for measurement application devices, wherein the control system comprises:
an augmented-reality display unit;
a device management unit configured to manage the measurement application devices communicatively connected to the control system; and
an output control unit configured to control the augmented-reality display unit such that augmented-reality display unit displays a status of a measurement task performed by the measurement application devices.

2. The control system according to claim 1, wherein the device management unit or the output control unit is further configured to adjust a background color in the augmented-reality display unit based on the status.

3. The control system according to claim 1, wherein the device management unit or the output control unit is further configured to adjust a background color in the augmented-reality display unit based on a currently controlled measurement application device.

4. The control system according to claim 3, wherein the device management unit or the output control unit is further configured to select the currently controlled measurement application device based on a physical distance of a user from the measurement application devices or a viewing direction of the user.

5. The control system according to claim 1, further comprising an input unit configured to detect input gestures of a user and to control the augmented-reality display unit, or at least one of the measurement application devices, or the augmented-reality display unit and at least one of the measurement application devices based on the detected input gestures.

6. The control system according to claim 5, wherein the input unit is further configured to adapt the input gestures based on the status or a currently controlled measurement application device.

7. The control system according to claim 5, wherein the input unit is further configured to adapt an effect of the input gestures based on the status, or a currently controlled measurement application device, or a distance of a user to a currently controlled measurement application device.

8. The control system according to claim 5, wherein the input unit is further configured to receive an input gesture for selecting several of the measurement application devices and to apply subsequent input gestures to the selected measurement application devices.

9. The control system according to claim 1, wherein the output control unit is configured to display different information of the status on different surfaces of a three-dimensional body in the augmented-reality display unit.

10. A measurement application system comprising:
at least one measurement application device; and
at least one control system comprising:
an augmented-reality display unit,
a device management unit configured to manage the at least one measurement application device communicatively connected to the at least one control system, and
an output control unit configured to control the augmented-reality display unit such that augmented-reality display unit displays a status of a measurement task performed by the at least one measurement application device,
wherein the at least one measurement application device is communicatively coupled to the at least one control system.

11. The measurement application system according to claim 10, further comprising at least one device under test communicatively coupled to the at least one control system.

12. (canceled)

13. Computer-implemented method for operating a measurement application system, the method comprising:
receiving status information from measurement application devices of the measurement application system;
determining a status of a measurement task performed by the measurement application devices; and outputting the status determined based on the status information in an augmented-reality display unit.

14. The method according to claim 13, further comprising adjusting a background color in the augmented-reality display unit based on the status.

15. Method according to claim 13, further comprising adjusting a background color in the augmented-reality display unit based on a currently controlled measurement application device.

16. The method according to claim 15, further comprising selecting the currently controlled measurement application device based on a physical distance of a user from the measurement application devices or a viewing direction of the user.

17. The method according to claim 13, further comprising detecting input gestures of a user and controlling the augmented-reality display unit, or at least one of the measurement application devices, or the augmented-reality display unit and at least one of the measurement application devices based on the detected input gestures.

18. The method according to claim 17, further comprising adapting the input gestures based on the status or a currently controlled measurement application device.

19. The method according to claim 17, further comprising adapting an effect of the input gestures based on the status, or a currently controlled measurement application device, or a distance of a user to a currently controlled measurement application device.

20. The method according to claim 17, further comprising receiving an input gesture for selecting several of the measurement application devices and applying subsequent input gestures to the selected measurement application devices.

21. The method according to claim 13, further comprising displaying different information of the status on different surfaces of a three-dimensional body in the augmented-reality display unit.
